(19) United States
(12) Patent Application Publication
(10) Pub. No.: US 2014/0101260 A1
(43) Pub. Date: Apr. 10, 2014

(54) PROCESSING A TECHNICAL SYSTEM

(71) Applicant: SIEMENS AKTIENGESELLSCHAFT, Munchen (DE)

(72) Inventor: Manfred Langen, Munchen (DE)

(73) Assignee: SIEMENS AKTIENGESELLSCHAFT, Munchen (DE)

(21) Appl. No.: 13/646,203

(22) Filed: Oct. 5, 2012

(51) Int. Cl. G06F 15/16

(52) U.S. Cl. 709/206

(57) ABSTRACT

Unstructured knowledge may be utilized to derive an action to be initiated by a technical system based on a problem that occurred on said technical system (e.g., a device). Such action may be derived by posting the problem, e.g., in textual form, in a social network, e.g., a forum of the Internet. Comments or answers to such posting may be automatically analyzed, e.g., by textual understanding, and a promising action may be mapped and executed (if applicable, e.g., associated with an appropriate level of confidence). This solution may provide a cost-efficient and automated exploration of unstructured knowledge in a social network to solve the problem of the technical system. The solution may be applicable for all kinds of technical systems, e.g., industry and automation systems, e.g., energy processing means, air conditioning systems, processing or delivery systems.

### TECHNICAL FIELD

This disclosure relates to a method for processing a technical system and to an according technical system or device.

### BACKGROUND

During operation, technical systems produce and indicate failure messages (also alarms, warnings, etc.). In several scenarios, it is difficult to assess whether a warning of a complex technical systems has an immediate effect on its functionality or an impact on the safety of the operation. In addition, efforts and/or costs regarding maintenance or repair with regard to the warning can be unclear.

In today's systems, the help or expertise of an experienced service technician is utilized in order to find appropriate counter-measures based on the actual warning. Then, subsequent steps can be initiated regarding, e.g., analysis, diagnosis and/or repair of the system or one of its components.

For safety reasons, in many cases a complex system or device will be shut down or switched to an inactive state if a failure occurs. The service technician is informed, who sometimes gets access to the system or device via remote services. Without full knowledge of the reason of the failure, there is no strategy for an automated solution.

### SUMMARY

In one embodiment, a method for processing a technical system is provided, wherein a problem is determined, wherein the problem is posted in a social network, wherein at least one feedback to the posted problem is analyzed, and wherein based on such analysis, an action to correct the problem is initiated.

In a further embodiment, the technical system comprises at least one of the following: a manufacturing system, a supply chain, a delivery system, a mechanical device, an electrical device, a generator, and an air conditioning system. In a further embodiment, the social network comprises a platform to which problems, in particular descriptions of problems can be supplied. In a further embodiment, the social network may be or comprise at least one of the following: a discussion platform in a network, in particular the Internet; a question & answer source; and a request form accessible via a network, in particular the Internet. In a further embodiment, the social network is accessible via a fixed line and/or a wireless connection. In a further embodiment, the social network is accessible via the Internet. In a further embodiment, the analysis of the answer comprises: mapping the analysis of the answer to a potential action; and determining a confidence measure indicating a level of confidence for the potential action. In a further embodiment, the potential action is used as action to be initiated to correct the problem, if the level of confidence reaches or exceeds a predetermined threshold. In a further embodiment, the analysis comprises means for textual understanding, in particular natural language processing. In a further embodiment, said method is part of an escalation scheme for solving the problem.

In another embodiment, a device or technical system comprises a processing unit that is arranged for determining a problem is determined, posting the problem in a social network, obtaining feedback to the problem posted, analyzing said feedback, and initiating an action to correct the problem based on such analysis.

### BRIEF DESCRIPTION OF THE DRAWINGS

Example embodiments will be explained in more detail below with reference to figures, in which:

FIG. 1 shows a schematic diagram visualizing the scenario described herein; and

FIG. 2 shows a schematic flow diagram of the communication scheme between the technical system and an exemplary database run on the device.

### DETAILED DESCRIPTION

Some embodiment provide an improved approach for a technical system or device, e.g., supply chain, manufacturing system, delivery system or the like, and/or a component thereof, to ensure an automated approach to solve a problem, e.g., deal with a warning or failure measure, even in case the system is (yet) unaware of the cause for the problem.

For example, some embodiments provide a method for processing a technical system,
wherein a problem is determined,
wherein the problem is posted in a social network,
wherein at least one feedback to the posted problem is analyzed,
wherein based on such analysis, an action to correct the problem is initiated.

Said feedback may be an answer provided by any device connected to the social network.

A promising action can be found and initiated in a cost-efficient and automated way. Knowledge available on demand via such social network can be utilized in order to find information which is otherwise difficult to discover. This approach can in particular be part of a workflow that supports systematic escalation in finding a solution to said problem. The approach can also be applied in an iterative manner.

In one embodiment, the technical system comprises at least one of the following:
a manufacturing system,
a supply chain,
a delivery system,
a mechanical device,
an electrical device,
a generator,
an air conditioning system.

In another embodiment, the social network comprises a platform to which problems, in particular descriptions of problems, can be supplied.

In a further embodiment, the social network may be or comprise at least one of the following:
a discussion platform in a network, in particular the Internet;
a question & answer source,
a request form accessible via a network, in particular the Internet.

In another embodiment, the social network is accessible via a fixed line and/or a wireless connection.

In some embodiments the social network is accessible via the

Internet.

In another embodiment, the analysis of the answer comprises:
mapping the analysis of the answer to a potential action;
determining a confidence measure indicating a level of confidence for the potential action.

According to one embodiment, the potential action is used as an action to be initiated to correct the problem, if the level of confidence reaches or exceeds a predetermined threshold.

According to another embodiment, the analysis comprises means for textual understanding, in particular natural language processing.

In yet another embodiment, said method is part of an escalation scheme for solving the problem.

Other embodiments provide a device or technical system comprising a processing unit that is arranged for
determining a problem is determined,
posting the problem in a social network,
obtaining feedback to the problem posted,
analyzing said feedback,
initiating an action to correct the problem based on such analysis.

It is noted that the steps of the method stated herein may be executable on this processing unit as well.

It is further noted that said processing unit can comprise at least one, in particular several means that are arranged to execute the steps of the method described herein. The means may be logically or physically separated; in particular several logically separate means could be combined in at least one physical unit.

Said processing unit may comprise at least one of the following: a processor, a microcontroller, a hard-wired circuit, an ASIC, an FPGA, a logic device.

The solution provided herein may include a computer program product directly loadable into a memory of a digital computer, comprising software code portions for performing the steps of the method as described herein.

In addition, the problem stated above may be solved by a computer-readable medium, e.g., storage of any kind, having computer-executable instructions adapted to cause a computer system to perform the method as described herein.

Furthermore, the problem stated above may be solved by a system comprising at least one device as described herein.

The solutions presented herein may utilize at least one strategy for solving a problem of a technical system (e.g., a device), which is, e.g., indicated by an error message, a warning, an alarm, a failure, or the like. Such strategy (escalation scheme) may involve at least one of the following:
(1) Structured knowledge for known problems;
(2) Structured knowledge for unknown problems, which are to some extend related or similar to known problems;
(3) Unstructured knowledge for unknown problems;
(4) Also in particular for unknown problems: social knowledge, e.g., ad-hoc knowledge provided via social interfaces, e.g. forums, blogs, questions & answers, dialogues, etc. accessible, e.g., via a network such as the Internet.

In particular, different kinds of knowledge, e.g., knowledge according to any of (1) to (4) above can be used within a workflow of escalation, also referred to as “escalation scheme”, which may comprise several levels, which may be processed one after the other, wherein the next level of escalation may only be initiated in case the problem could not yet be solved.

Based on the level of escalation, at least one action can be triggered to solve the problem. If the problem cannot be solved by this action, the next step of escalation can be initiated.

The at least one action may be or include:
a restart of the system or device;
updating software and/or firmware;
continue operating the system; order a replacement part and install the replacement part when available;
stop the system; inform service technician to repair the system.

Based on the system and/or domain of application, there can be a predefined number of actions in case a problem occurs. For example, a logic or control may find a suitable action on a first level of escalation: a rule-based system or a request directed to a database may be used to solve the problem via an appropriate action.

If no suitable action can be found or if an action does not solve the problem, the next level of escalation could utilize machine knowledge (e.g., rule-based systems, ontologies, textual interpretation) to find a promising action. On this level of escalation a confidence measure is introduced based on the concept of similarity and/or the fact that the data utilized is not structured. In this case, the analysis is not based on assured (or trusted) knowledge and a result is accompanied by a portion of uncertainty, which is often expressed in a range between 0% and 100%.

A threshold can be set for this uncertainty indicating the actual level of confidence required for considering and/or executing an action. In other words, if the confidence reaches or exceeds such predefined threshold, the corresponding action could be triggered trying to solve the problem. On the other hand, if the confidence measure for an action does not at least reach this threshold, it will not be used. Instead, a subsequent level of escalation can be commenced.

If there is no additional level of escalation left that could provide automated support, it is an option to issue a message indicating this circumstance and to put the system to a halt and/or inform a service technician to solve the problem.

Before such escalation, i.e. before informing the service technician (it is also a possibility, of course, to inform the service technician despite all automated efforts), it is an option for the system to utilize knowledge of a social network, also referred to as “social knowledge”. Such knowledge may stem from various sources, e.g.:
a discussion platform in a network, in particular the Internet (also referred to as a “forum”);
a question & answer source (also referred to as Q&A source), which may be provided over, e.g., the Internet and may be structured according to problems, types of failures or defects, malfunctions, devices, environment, surroundings of the devices, mode of operation, application, etc.
a request form, which may be used (i.e. completed) to obtain answers or feedback on a particular problem.

These types of social knowledge may be supplied by more or less experienced experts in various technical fields and/or by other devices or systems.

In some embodiments the system by itself may issue a contribution (e.g., a posting by filling out a form or by entering a description of the problem into a discussion platform of the Internet) describing the current problem, e.g., in a textual manner. The system may then check regularly whether the contribution is answered and analyzes such answer (if available). This can be done, e.g., via textual analysis or textual understanding (e.g., via NLP (natural language processing) techniques) to find a clue towards solving the problem. The information provided via this route can be mapped to potential actions and a confidence measure can be determined for each such mapping.

These types of knowledge triggered by a contribution of the system can be regarded as “unstructured knowledge for unknown problems” according to (3) above.

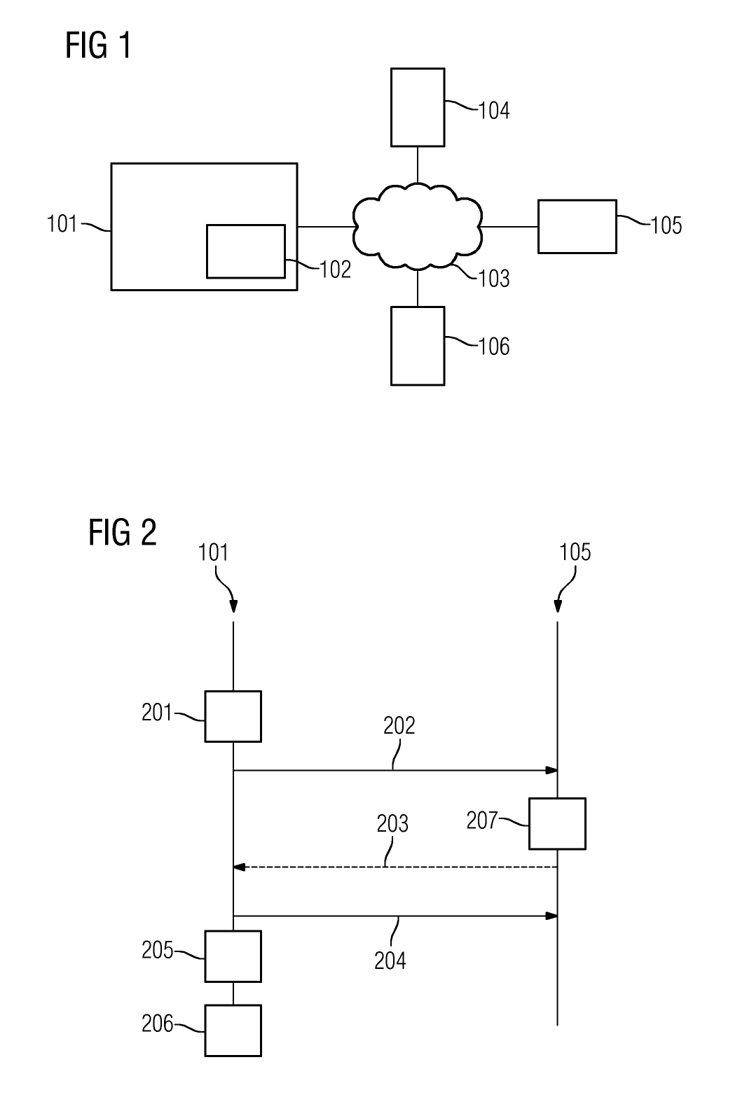

FIG. 1 shows a schematic diagram visualizing the scenario described herein. A technical system 101 (also a device could be regarded as technical system) comprises a processing unit 102, e.g., a microcontroller, a control unit, a processor, an FPGA or the like and has access to a network 103, e.g., the Internet. This network 103 is also accessible to various other devices 104 to 106. Also, further devices (not shown) may be part of the network 103, e.g., databases, additional computers, networks, databases, etc. The technical system 101 thus has access to the network 103 and may post a problem as request in a forum or the like. An answer from any other device 104 to 106 can be analyzed in an automated way and used to map it to an optional action, which can be executed in case a confidence measure for such mapping reaches or exceeds a predefined threshold.

FIG. 2 shows a schematic flow diagram of the communication scheme between the technical system 101 and an exemplary data-base run on the device 105, e.g., a forum that may be made accessible via the network 103.

In a step 201 a problem is determined by the technical system. This can be achieved, e.g., by condition monitoring means. The problem is then posted (see step 202) in a textual form on the forum that is provided by the device 105. In a step 207 a comment or answer to the posting 202 is entered (this can be done at the device 105 or any other device connected to said forum).

As an option, in a step 203, the device 105 informs the technical system 101 that a comment to its posting has been received. It may also convey the content of such comment to the technical system 101 (in this case the next step 204 may be omitted).

The technical system in a step 204 may check (e.g., on a regular basis), whether any comment or answer to its posting has been provided, downloads this comment and analyzes it (e.g., via means of textual processing) in a step 205.

In a subsequent step 206 the technical system 101 derives an action based on the textual processing of the comment and assesses whether or not such action has a confidence measure high enough to be executed. In the affirmative, the action is initiated and—as a best case scenario—the problem is solved. If the problem is not solved by such action, the mechanism described may be run again and/or a next level of escalation, e.g., requesting a service technician to repair the technical system 101, can be initiated.

The approach presented may provide an automated technique for finding a solution to the problem of the system or device, which may be fast and cost effective. The systematic escalation allows for transparency of the workflow; the attempt to solve a problem is in particular traceable based on such workflow (e.g., if knowledge of the social network is utilized it may—based on the workflow implemented—become clear that the remaining sources to find an appropriate action to solve the problem have failed).

Further, speed, safety and cost can be accounted for in an escalation scheme that fits the respective technical system and the requirements determined for such technical system and/or the domain of application.

Exemplary Embodiment: Turbine

Hereinafter, an exemplary embodiment is described with regard to a turbine as a technical system. Of course, other technical systems (including single devices or combined devices) may be utilized in a similar way.

The condition of the turbine is monitored continuously. A condition monitoring (entity or system) creates a warning indicating that a temperature value is too high. This may happen when the turbine during a start-up phase from partial load to full load temporarily reaches a temperature that is too high, but still in an acceptable range.

Based on a service report of a different but comparable turbine the information can be extracted that such an incident is based on a gradual weariness of the pump output of the cooling system. This can be remedied by replacing the respective pump. Hence, the problem can be solved by utilizing unstructured knowledge for unknown problems via the action “continue operating the system; order a replacement part and install the replacement part when available”.

Exemplary Embodiment: Air Conditioning System

An outage of an air conditioning system of a building may not be solved via the escalation levels (1), (2) or (3). An error message describing the air conditioning system, the type of failure and environmental conditions is thus posted in a forum and flagged as “urgent request”. The forum may be part of a social network accessible via the Internet.

A service technician who recently faced the same or a similar problem reads the post and provides an answer indicating that the air conditioning system worked well after having replaced component xyz. By automated means of textual understanding the system analyses the answer and recognizes that the problem may be solved by replacing the component xyz. This can be mapped to a potential action (with a confidence measure) and such action can be executed to remedy the outage of the air conditioning system.

It is proposed to utilize unstructured knowledge to derive an action to be initiated by a technical system based on a problem that occurred on said technical system (which may also be a device). Such action is derived by posting the problem, e.g., in textual form, in a social network, e.g., a forum of the Internet. Comments or answers to such posting are automatically analyzed, e.g., by means of textual understanding, and a promising action is mapped and executed (if applicable, e.g., associated with an appropriate level of confidence). The disclosed embodiments may provide a cost-efficient and automated exploration of unstructured knowledge in a social network to solve the problem of the technical system. Embodiments may be applicable for many or all kinds of technical systems, e.g., industry and automation systems, e.g., energy processing means, air conditioning systems, processing or delivery systems.

Although the invention is described in detail by the example embodiments above, it is noted that the invention is not at all limited to such example embodiments. In particular, alternatives can be derived by a person skilled in the art from the exemplary embodiments and the illustrations without exceeding the scope of this invention.

What is claimed is:

1. A method for processing a technical system, comprising
determining a problem regarding the technical system,
posting the problem in an online social network,
analyzing at least one feedback to the posted problem, and
based on such analysis, automatically initiating an action to correct the problem.

2. The method of claim 1, wherein the technical system comprises at least one of the following:
a manufacturing system,
a supply chain,
a delivery system,
a mechanical device,
an electrical device,
a generator, and
an air conditioning system.

3. The method of claim 1, wherein the social network comprises a platform that is supplied with descriptions of problems.

4. The method of claim 1, wherein the social network comprises at least one of the following:
a discussion platform in a network, in particular the Internet;
a question & answer source; and
a request form accessible via the Internet.

5. The method of claim 1, wherein the social network is accessible via at least one of a fixed line and a wireless connection.

6. The method of claim 1, wherein the social network is accessible via the Internet.

7. The method of claim 1, wherein analyzing at least one feedback to the posted problem comprises:
mapping the analysis of the answer to a potential action; and
determining a confidence measure indicating a level of confidence for the potential action.

8. The method of claim 7, comprising initiating the potential action if the level of confidence reaches or exceeds a predetermined threshold.

9. The method of claim 1, wherein analyzing at least one feedback to the posted problem comprises natural language processing.

10. A device or technical system comprising:
a processor programmed to:
determine a problem is determined,
post the problem in an online social network,
obtain feedback to the problem posted,
analyze said feedback, and
automatically initiate an action to correct the problem based on such analysis.12.The device of claim 11, wherein the device or technical system comprises at least one of the following:
a manufacturing system,
a supply chain,
a delivery system,
a mechanical device,
an electrical device,
a generator, and
an air conditioning system.

11. The device of claim 10, wherein the social network comprises a platform that is supplied with descriptions of problems.

12. The device of claim 10, wherein the social network comprises at least one of the following:
a discussion platform in a network, in particular the Internet;
a question & answer source; and
a request form accessible via the Internet.

13. The device of claim 10, wherein the social network is accessible via at least one of a fixed line and a wireless connection.

14. The device of claim 10, wherein the social network is accessible via the Internet.

15. The device of claim 10, wherein analyzing at least one feedback to the posted problem comprises:
mapping the analysis of the answer to a potential action; and
determining a confidence measure indicating a level of confidence for the potential action.

16. The device of claim 15, wherein the processor is programmed to initiate the potential action if the level of confidence reaches or exceeds a predetermined threshold.

17. The device of claim 10, wherein analyzing at least one feedback to the posted problem comprises natural language processing.
